(19) United States
(12) Patent Application Publication
(10) Pub. No.: US 2010/0112380 A1
(43) Pub. Date: May 6, 2010

(54) Electricity Generation in Single-Chamber Granular Activated Carbon Microbial Fuel Cells Treating Wastewater

(75) Inventor: Baikun Li, Vernon, CT (US)

Correspondence Address: MCCARTER & ENGLISH, LLP STAMFORD, CANTERBURY GREEN, 201 BROAD STREET, 9TH FLOOR, STAMFORD, CT, 06901, US

(73) Assignee: UNIVERSITY OF CONNECTICUT, Farmington, CT (US)

(21) Appl. No.: 12/557,666

(22) Filed: Sep. 11, 2009

Related U.S. Application Data
(60) Provisional application No. 61/096,058, filed on Sep. 11, 2008.

(51) Int. Cl. H01M 8/16

(52) U.S. Cl. 429/2

(57) ABSTRACT

An apparatus and method for producing electrical power and treating wastewater is provided. The apparatus and method oxidize bacteria and substrates naturally occurring in wastewater in a chamber, generating electrons which run from an anode to a cathode through an associated circuit. As a result of the oxidation reactions, the apparatus and method remove impurities from the wastewater and generate electrical power.

### CROSS-REFERENCE TO RELATED APPLICATIONS

This application claims the benefit of U.S. Provisional Application No. 61/096,058 filed Sep. 11, 2008, all of which is herein incorporated in its entirety.

### BACKGROUND

1. Technical Field

The present disclosure generally relates to the fields of electrical power generation and wastewater treatment. More particularly, the present disclosure relates to the generation of electrical power (e.g., sustainable electrical power) from the use of microbial fuel cells in the treatment of wastewater.

2. Background Art

As natural energy reserves dwindle and carbon dioxide generation increases, a global concern about energy shortage and environmental quality has generally intensified. In the United States alone, the typical daily consumptions of oil and coal are approximately 20 million barrels and 300 million tons, respectively, while the daily emission of carbon dioxide is approximately 34 million tons. The development of renewable fuels with less environmental pollution has become a priority for environmental sustainability and energy independence.

In general, wastewater treatment is important for protecting the environment and maintaining human health. However, such treatment systems typically consume enormous amounts of energy, and are usually the single largest consumers of power for municipalities. It is estimated that the 60,000 water treatment systems and 15,000 wastewater treatment systems in the United States account for more than 35% of total municipal energy usage and approximately 3-5% of the nation's overall electric load. As populations grow, and environmental requirements become more stringent, the demand for energy in water and/or wastewater treatment is expected to grow by up to 20% during the next fifteen years.

In general, the primary technology for treating municipal, agricultural and industrial wastewater in the United States is aerobic activated sludge, an energy intensive process that was developed more than a century ago. Aerobic treatment processes typically require significant amounts of oxygen, pumping capacities and/or air supplies, and can consume as much as 70% of the energy used in wastewater treatment processes. Therefore, developing new approaches to reduce energy consumption in wastewater treatment systems is important for environmental sustainability and economic vitality.

Although today's wastewater treatment processes still typically reflect high levels of energy consumption, wastewater itself may be an energy pool. Significant amounts of potential energy are generally stored in wastewater as a form of reduced organic contaminant (e.g., carbohydrates, proteins, fatty acids, etc.). With approximately over sixty billion gallons of wastewater being generated daily in the United States, wastewater contains a large supply of organic substrates. Consequently, harnessing energy during wastewater treatment processing is important to the long term development of sustainable energy production and environmental protection.

The use of microbial fuel cells (MFCs) to generate electricity from organic substances is generally known to those of skill in the art, and is a promising source for renewable energy. Compared with traditional fuel cells, which typically use pure organic sources and expensive catalysts at high temperatures and high pressures in order to generate electricity, MFCs generally operate under normal temperature and pressure conditions and at lower costs. Moreover, because the oxidation reactions which occur in a MFC typically do not require aeration, MFCs are generally associated with lower power requirements.

Traditional two-chamber MFCs typically consist of individual chambers for an anode and a cathode, respectively. In general, the chambers are separated by a proton exchange membrane and are electrically connected through an external circuit. In the anode chamber, bacteria generate electrons and gain energy for growth by oxidizing substrates contained therewithin (e.g., carbohydrates such as glucose, acetate or other constituents). Electricity is then typically produced by transferring the generated electrons to the anode. Protons created as a result of the substrate oxidation migrate through the proton exchange membrane and combine with the electrons in the presence of oxygen at the cathode to form water. In such MFCs, the electrodes may include various forms of conductive material, although carbon paper or carbon cloth, such as those manufactured by the E-TEK Division of BASF Fuel Cell, Inc., are commonly used, while materials such as a sulfonated tetrafluorethylene copolymer (e.g., Nafion) may be used as exchange membranes in two-chamber MFCs. Electrodes may be further enhanced with catalysts, such as platinum (Pt), to improve their performance. Nafion may also be used as a catalyst.

From an engineering standpoint, MFC technology may be considered a biofilm-based process, since bacteria within the MFC oxidize substrates by attaching and/or adhering to an electrode surface (e.g., anodic surface) for electron transfer. In other words, MFCs generally depend on bacterial adhesion and biofilm growth to transfer electrons from bacteria to electrodes. Thus, the macro-scale engineering performance of MFC technology generally depends on the micro-scale interactions between the bacteria and the electrode, especially electron transfer from the bacteria to the electrode. Although MFC performance has been substantially improved in the past several years, the realized power generation using standard electrode materials is still low, with reported performance at just over four watts per square meter (W/m²) of electrode surface area. See K. Rabaey et al., “A Microbial Fuel Cell Capable of Converting Glucose to Electricity at High Rate and Efficiency,” Biotechnology Letters, vol. 25, pp. 1531-1535 (2003).

Recently, Logan et al. described the use of a single-chamber MFC to generate electricity. B. E. Logan et al., “Electricity-Producing Bacterial Communities in Microbial Fuel Cells,” Trends in Microbiology, vol. 14, no. 12, at 512-513 (2006). The single-chamber MFC described therein includes an open ended chamber and both an anode and a cathode, but lacks an exchange membrane. The two electrodes are fixed at opposite ends of the chamber, with the anode embedded at the base of the closed end of the chamber, and the two-sided cathode forming a water-tight seal on the open end of the chamber, which is filled with a biodegradable substrate and exoelectrogenic bacteria. One face of the cathode is exposed to the substrate solution, while the other face is exposed to air. Cheng et al. later determined that providing continuous advective flow through a porous anode toward the cathode in a single-chamber MFC can provide increased power densities over two-chamber MFCs. S. Cheng et al., “Increased Power Generation in a Continuous Flow MFC with Advective Flow through the Porous Anode and Reduced Electrode Spacing,” Environ. Sci. Technol., vol. 40, no. 7, pp. 2426-2432 (2006). However, the MFCs in the Cheng et al. study utilized standard carbon cloth as an anode in the single-chamber, and their power-generation performance was hindered, at least in part, by the poor bacterial adherence qualities of the electrodes utilized therein.

Engineering studies have noted improvements in power generation in MFCs by changing operating conditions, such as substrate concentration, ionic strength, temperature and electrode materials. See, e.g., H. Liu et al., “Power Generation in Fed-Batch Microbial Fuel Cells as a Function of Ionic Strength, Temperature and Reactor Configuration,” Environ. Sci. Technol., vol. 39, no. 14, pp. 5488-5493 (2005). However, because the biofilm-based process in a MFC generally depends on micro-scale interactions between the bacteria in the substrate and the anodic surfaces, improving the overall performance of the MFC typically requires improving the quality and efficiency of the interactions between bacteria and the anodes.

In general, a number of limitations continue to restrict the use of two-chamber MFCs. For example, MFCs with multiple chambers have significant internal resistance, due at least in part to the transfer of protons through the proton exchange membrane. This high internal resistance can cause substantial energy loss within the MFCs themselves, which makes less energy available for external use. The proton exchange membrane itself adds to the cost of an MFC, as such membranes can be extremely expensive. Also, MFCs with multiple chambers typically feature a number of bulky components and therefore require large spaces to create energy.

Accordingly, there exists a need for an improved apparatus and systems/methods for effectively and efficiently converting the potential energy inherently present in wastewater into useful electrical energy while treating the wastewater for subsequent use. These and other inefficiencies and opportunities for improvement are addressed and/or overcome by the systems and methods of the present disclosure.

### SUMMARY

According to the present disclosure, advantageous apparatus, systems and methods for achieving energy production from the treatment of source material, e.g., wastewater, through the use of microbial fuel cells (MFCs), are provided. Exemplary embodiments of the disclosed apparatus/methods utilize MFC technology in a single chamber that includes granular activated carbon to generate electricity from wastewater.

Thus, in exemplary implementations of the present disclosure, a wastewater influent/feed stream that includes bacteria and organic components, such as, for example, carbohydrates, proteins and/or fatty acids, is fed into a single chamber which contains or is otherwise associated with both a cathode and an anode. Within the chamber, the bacteria and organic components are oxidized in the presence of water, and electrons are externally communicated from the anode to the cathode, which is in the presence of air, by way of an electrical connection containing an external resistance. The resulting effluent is fed from the chamber, and portions may be recirculated into the influent, or otherwise transferred for further processing.

In a preferred aspect of the present disclosure, the anode includes activated carbon (e.g., granular activated carbon) which provides an enhanced capacity for bacterial adhesion, bacterial growth and/or biofilm growth and, therefore, electrical conduction. In another aspect of the present disclosure, the single chamber includes a pair of outlets for the effluent, and a pair of anodic bases within the chamber. The cathodes of this aspect of the present disclosure may be positioned outside of the chamber, and the cathodes and anodic bases are generally separated by an insulating material.

The disclosed apparatus, systems and methods provide significant improvements over previously existing technologies for energy production using microbial fuel cells. More particularly, the advantages of the present disclosure over existing single-chamber MFCs include greater bacterial adhesion of the anodic materials utilized, greater bacterial and/or biofilm growth, and resulting improved electrical conductive performance. The disclosed apparatus, systems and methods may be utilized alone or in combination with other apparatus and/or methods, e.g., for wastewater treatment, and provide improved energy efficiency as compared to similar devices of the prior art.

The present disclosure also provides for a microbial fuel cell for generating electrical power including a chamber that defines an inlet and an outlet, the chamber having a top side defining a substantially horizontal plane; and an anode and a first cathode associated with the chamber, wherein the anode is defined at least in part from granular activated carbon. The present disclosure also provides for a MFC wherein the chamber is adapted to receive a bacteria-containing substrate through the inlet. The present disclosure also provides for a MFC wherein the granular activated carbon is present in an amount effective to facilitate bacterial adhesion thereto. The present disclosure also provides for a MFC wherein the chamber defines a single cell configuration. The present disclosure also provides for a MFC wherein the granular activated carbon is positioned in a lower portion of the chamber and the first cathode is positioned in an upper portion of the chamber.

The present disclosure also provides for a MFC wherein the first cathode takes the form of carbon cloth. The present disclosure also provides for a MFC further including a conductive member to facilitate electron transfer from the anode to the first cathode. The present disclosure also provides for a MFC wherein operation is adjusted by controlling processing parameters selected from the group consisting of effluent recirculation, anode and first cathode spacing, conductive member selection and positioning, bacterial concentration of influent, bacterial composition of influent, geometry of chamber, and combinations thereof.

The present disclosure also provides for a MFC wherein at least a portion of the conductive member is vertically oriented within the chamber at an acute angle or perpendicular relative to the horizontal plane of the top side of the chamber. The present disclosure also provides for a MFC wherein the first cathode is oriented at an acute angle or perpendicular relative to the horizontal plane of the top side of the chamber. The present disclosure also provides for a MFC wherein the first cathode is oriented at an acute angle or perpendicular relative to the horizontal plane of the top side of the chamber. The present disclosure also provides for a MFC further including a plurality of cathodes associated with the chamber. The present disclosure also provides for a MFC wherein the first cathode is oriented at an acute angle or perpendicular relative to the horizontal plane of the top side of the chamber; and wherein each cathode of the plurality of cathodes is oriented at an acute angle or perpendicular relative to the horizontal plane of the top side of the chamber.

The present disclosure also provides for a MFC further including a plurality of conductive members, each conductive member of the plurality of conductive members configured to facilitate electron transfer from the anode to the first cathode. The present disclosure also provides for a MFC wherein at least a portion of each conductive member of the plurality of conductive members is vertically oriented within the chamber at an acute angle or perpendicular relative to the horizontal plane of the top side of the chamber. The present disclosure also provides for a MFC further including a plurality of cathodes associated with the chamber and a plurality of conductive members; wherein the first cathode and each cathode of the plurality of cathodes is oriented at an acute angle or perpendicular relative to the horizontal plane of the top side of the chamber; and wherein at least a portion of each conductive member of the plurality of conductive members is vertically oriented within the chamber at an acute angle or perpendicular relative to the horizontal plane of the top side of the chamber.

The present disclosure also provides for a MFC wherein the first cathode and each cathode of the plurality of cathodes is electrically connected to one individual conductive member of the plurality of conductive members, thereby forming a plurality of individual electrical circuits. The present disclosure also provides for a MFC wherein the number of conductive members in the plurality of conductive members equals the number of cathodes in the plurality of cathodes plus the first cathode. The present disclosure also provides for a MFC wherein the number of individual electrical circuits in the plurality of individual electrical circuits equals the number of conductive members in the plurality of conductive members.

The present disclosure also provides for a MFC wherein the first cathode and each cathode of the plurality of cathodes of the MFC is positioned in an upper portion of the chamber. The present disclosure also provides for a MFC wherein the portion of the conductive member vertically oriented within the chamber extends from a lower portion of the chamber to an upper portion of the chamber. The present disclosure also provides for a MFC wherein each portion of each conductive member of the plurality of conductive members vertically oriented within the chamber extends from a lower portion of the chamber to an upper portion of the chamber.

The present disclosure also provides for a MFC further including a first anodic base, a second anodic base, and a second cathode associated with the chamber; wherein the first anodic base is positioned at a first end of the chamber and the second anodic base is positioned at a second end of the chamber; and wherein the first cathode is positioned outside of the first end of the chamber and adjacent to the first anodic base, and the second cathode is positioned outside of the second end of the chamber and adjacent to the second anodic base. The present disclosure also provides for a MFC wherein a first insulating material is positioned between the first anodic base and the first cathode, and a second insulating material is positioned between the second anodic base and the second cathode.

The present disclosure also provides for a method for generating electrical power from a fluid source, the method including: (i) providing at least one microbial fuel cell that includes a chamber defining an inlet and an outlet; and an anode and a cathode associated with the chamber, wherein the anode is defined at least in part from granular activated carbon; (ii) feeding a fluid stream containing bacteria through the inlet into the chamber, said bacteria adhering at least in part to the granular activated carbon; (iii) oxidizing bacteria to generate current between the anode and cathode; and (iv) discharging effluent through the outlet of the chamber, wherein the effluent contains a reduced bacterial level as compared to the fluid stream fed to the chamber. The present disclosure also provides for a method for generating electrical power from a fluid source, wherein the fluid stream is wastewater.

The present disclosure also provides for a method for generating electrical power from a fluid source wherein the chamber defines a single cell configuration.

The present disclosure also provides for a method for generating electrical power from a fluid source wherein the granular activated carbon is positioned in a lower portion of the chamber and the cathode is positioned in an upper portion of the chamber. The present disclosure also provides for a method for generating electrical power from a fluid source wherein the cathode takes the form of carbon cloth. The present disclosure also provides for a method for generating electrical power from a fluid source further including a conductive member to facilitate electron transfer within the chamber. The present disclosure also provides for a method for generating electrical power from a fluid source wherein operation is adjusted by controlling processing parameters selected from the group consisting of effluent recirculation, anode and cathode spacing, conductive member selection and positioning, bacterial concentration of influent, bacterial composition of influent, geometry of chamber, and combinations thereof.

The present disclosure also provides for a microbial fuel cell for generating electrical power, including a chamber that defines an inlet and an outlet, the chamber having a top side defining a substantially horizontal plane; and an anode and a plurality of cathodes associated with the chamber, wherein the anode is defined at least in part from granular activated carbon; a plurality of conductive members, at least a portion of each conductive member of the plurality of conductive members being vertically oriented within the chamber at an acute angle or perpendicular relative to the horizontal plane of the top side of the chamber, with each portion of each conductive member of the plurality of conductive members vertically oriented within the chamber extending from a lower portion of the chamber to an upper portion of the chamber; wherein each cathode of the plurality of cathodes is positioned in an upper portion of the chamber, and each cathode of the plurality of cathodes being oriented at an acute angle or perpendicular relative to the horizontal plane of the top side of the chamber; wherein each cathode of the plurality of cathodes is electrically connected to one individual conductive member of the plurality of conductive members, thereby forming a plurality of individual electrical circuits; wherein the number of conductive members in the plurality of conductive members equals the number of cathodes in the plurality of cathodes; and wherein the number of individual electrical circuits in the plurality of individual electrical circuits equals the number of conductive members in the plurality of conductive members.

Additional features, functions and benefits of the disclosed apparatus, systems and methods will be apparent from the description which follows, particularly when read in conjunction with the appended figures.

### BRIEF DESCRIPTION OF THE DRAWINGS

To assist those of ordinary skill in the art in making and using the disclosed systems and methods, reference is made to the appended figures, wherein:

FIG. 1A shows an exemplary single-chamber microbial fuel cell that may be used according to the present disclosure;

FIG. 1B shows an alternative exemplary single-chamber microbial fuel cell that may be used according to the present disclosure;

FIG. 2 shows another exemplary single-chamber microbial fuel cell that may be used according to the present disclosure;

FIG. 3 shows an alternative exemplary single-chamber microbial fuel cell that may be used according to the present disclosure;

FIG. 4 shows another exemplary single-chamber microbial fuel cell that may be used according to the present disclosure;

FIG. 5 depicts a partial top perspective view of an exemplary MFC according to the present disclosure;

FIG. 6 depicts a partial side perspective view of an exemplary MFC according to the present disclosure;

FIG. 7 depicts power generation results at different wastewater contaminant concentrations for various exemplary MFCs according to the present disclosure; and

FIG. 8 shows an exemplary single-chamber microbial fuel cell that may be used according to the present disclosure.

### DETAILED DESCRIPTION

In general, there exists a need for an improved apparatus and improved systems/methods for effectively and efficiently converting the potential energy inherently present in wastewater into useful electrical energy while treating the wastewater for subsequent use. The present disclosure provides for improved and cost-efficient systems and methods for achieving energy production from the treatment of source material (e.g., wastewater) through the use of microbial fuel cells (MFCs), thereby providing a significant commercial and manufacturing advantage as a result. Exemplary embodiments of the disclosed apparatus/methods utilize MFC technology in a single chamber that includes granular activated carbon to generate electricity from wastewater. At least some advantages of the MFCs provided by exemplary embodiments of the present disclosure over existing single-chamber MFCs include greater bacterial adhesion of the anodic materials utilized, greater bacterial and/or biofilm growth, and resulting improved electrical conductive performance.

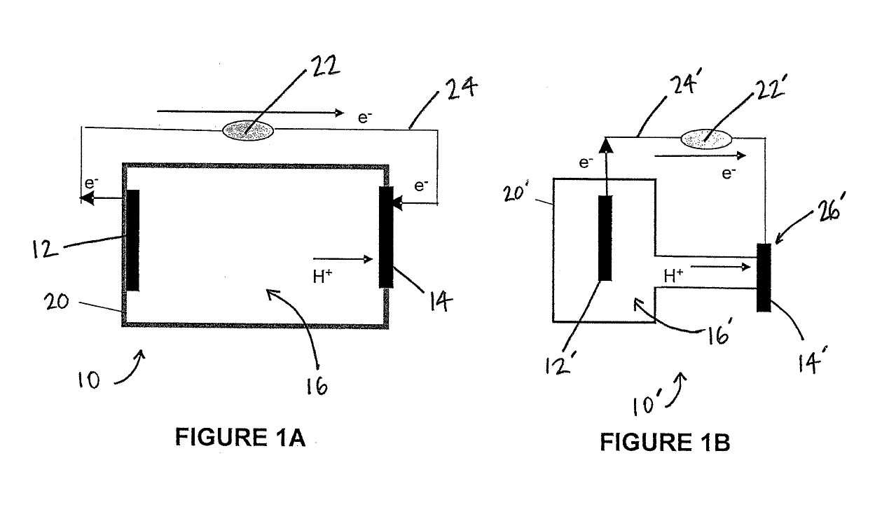

Referring now to the drawings, and in particular to FIGS. 1A and 1B, exemplary microbial fuel cells (which may be referred to herein as “microbial fuel cell,” “fuel cell” or “MFC”) of the present disclosure are indicated generally by the reference numeral 10, 10′. Fuel cell 10, 10′ generally includes or defines a single chamber 20, 20′. Fuel cell 10, 10′ generally includes an anode 12, 12′ and a cathode 14, 14′. Cathode 14, 14′ may take various forms and may be fabricated from known materials, e.g., a carbon cloth or the like.

The chamber 20, 20′ typically contains and/or receives a bacteria-containing substrate solution 16, 16′ (e.g., municipal, agricultural and/or industrial wastewater). Chamber 20, 20′ typically includes an inlet and an outlet for the solution. Within the chamber 20, 20′, bacteria from the bacteria-containing substrate solution 16, 16′ generate electrons and gain energy for growth by oxidizing substrates present in the wastewater (e.g., organic substrates, carbohydrates, such as glucose, acetate or other contaminants). The electrons generated by such bacteria-based oxidation are transferred to the anode 12, 12′. Protons created as a result of the substrate oxidation combine with the electrons in the presence of oxygen at the cathode 14, 14′, which is exposed to air, to form water. Electrons flow from the anode 12, 12′ to the cathode 14, 14′ through an external resistor 22, 22′, by way of an electrical circuit 24, 24′. In the embodiment shown in FIG. 1A, the fuel cell 10 is sometimes referred to as a “cube fuel cell,” and the cathode 14 is exposed to air.

In exemplary embodiments, MFC 10 includes an advantageous anode 12 that includes a bed of granular activated carbon (“GAC”). Bacteria from the bacteria-containing solution adhere to the GAC and, as they are oxidized, generate electrons. It has been found that GAC itself is an excellent conductor of electrons, which is important for MFCs. GAC has also been found to be a material with low resistance. Moreover, GAC has a very large surface area. As such, it has been found that very high densities of bacteria will grow on the GAC, and these very high densities of bacteria growing on the GAC can efficiently transfer electrons to the electrode (e.g., anode) and effectively degrade contaminants from the substrate solution (e.g., wastewater). The generated and transferred electrons flow from the anode 12 to the cathode 14 through the external resistor 22, by way of the electrical circuit 24.

By using GAC as the anode 12, exemplary MFC 10 has an anode with very high surface area for bacterial and/or biofilm growth. Moreover, exemplary single chamber MFC 10 has much lower internal resistance than a conventional two-chamber MFC, which thereby significantly reduces the energy loss inside MFC 10. Furthermore, the configuration of exemplary single chamber MFC 10 can easily be applied to wastewater applications, unlike two-chamber MFCs, which require large spaces.

The power generation and contaminant removal efficiency of exemplary MFC 10 has been found to have been improved substantially compared with two-chamber (e.g., carbon cloth) MFCs. Moreover, the cost of GAC is much lower compared to conventional electrode materials (e.g., polymer-coated electrodes, nanotube electrodes, carbon cloth, carbon paper, platinum, etc.).

A fuel cell 10′ similar to that shown in FIG. 1A is shown in FIG. 1B. In this embodiment, the fuel cell 10′ is sometimes referred to as a “bottle fuel cell.” The cathode 14′ is contained in an extension tube 26′ or the like, which may be made of glass or some other type of material, and the cathode 14′ may also be exposed to air.

Fuel cells such as those described in FIGS. 1A and 1B generate electricity by way of a number of electrical reactions. The theoretical maximum number of coulombs, or C_{T}, that may be produced in a fuel cell by the oxidation of a substrate i in the presence of bacteria may be calculated according to the following equation:

$${C}_{T} = \frac{{Fb}_{i} {S}_{i} v}{{M}_{i}} \qquad ( 1 )$$

wherein F is the Faraday constant, b₁ is the number of moles of electrons produced per mole of substrate i, Sᵢ stands for the concentrate of substrate i, v is the volume of liquid, and M is the molecular weight of the substrate i.

Similarly, the theoretical maximum amount of electrical energy E_{T} that may be created in such reactions may be calculated as:

$${E}_{T} = \frac{Δ {HS}_{i} v}{{M}_{i}} \qquad ( 2 )$$

wherein ΔH is the enthalpy change associated with the reaction of the electrical oxidation of the substrate i.

An exemplary anaerobic reaction for production of electrons (e⁻) and protons (or hydrogen nuclei, H⁺) from the oxidation of the substrate acetate (CH₃COOH) in the presence of water (H₂O) is:

CH₃COOH+2H₂O→8H⁺8e⁻+2CO₂ (3)

The electrons (e⁻) are attracted to the anode 12, and the protons (H⁺) to the cathode 14, creating an electrical potential between the electrodes and causing current to run through the external resistor 22. An aerobic reaction following the oxidation of acetate, above, the protons and the electrons combine to form water in the presence of oxygen (O₂) at the cathode 14:

8H⁺+8e⁻+2O₂→4H₂O (4)

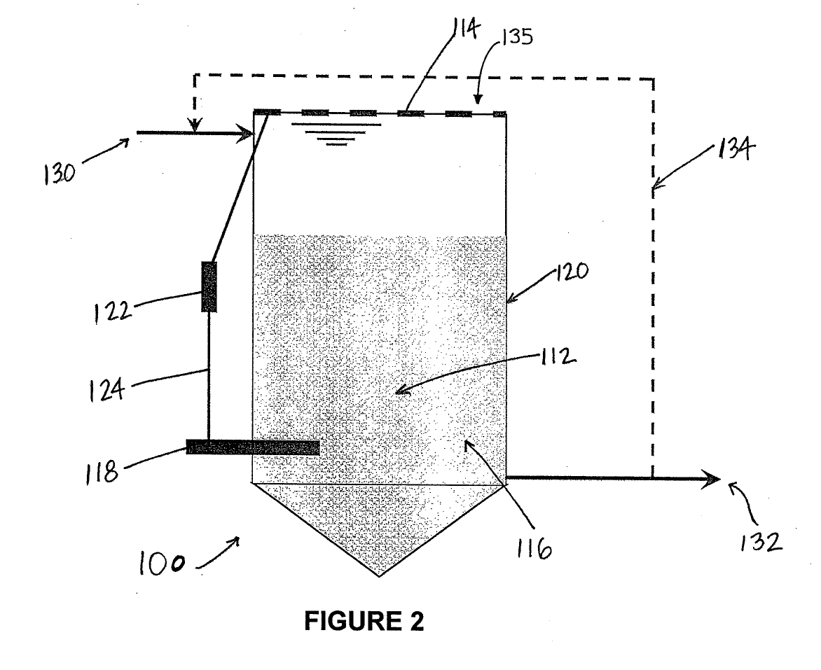

Turning now to FIGS. 2-6, fuel cell 100 includes or defines a single chamber 120. In general, chamber 120 is substantially cylindrically shaped, although the present disclosure is not limited thereto (e.g., alternative geometries may be employed without departing from the present disclosure). In exemplary embodiments, the chamber 120 is configured and dimensioned to house and/or contain from about one liter to about twenty liters of fluid. In general and as shown in FIGS. 2-6, chamber 120 has a top side 135 that defines a substantially horizontal plane. Top side 135 of MFC 100 may be open or closed.

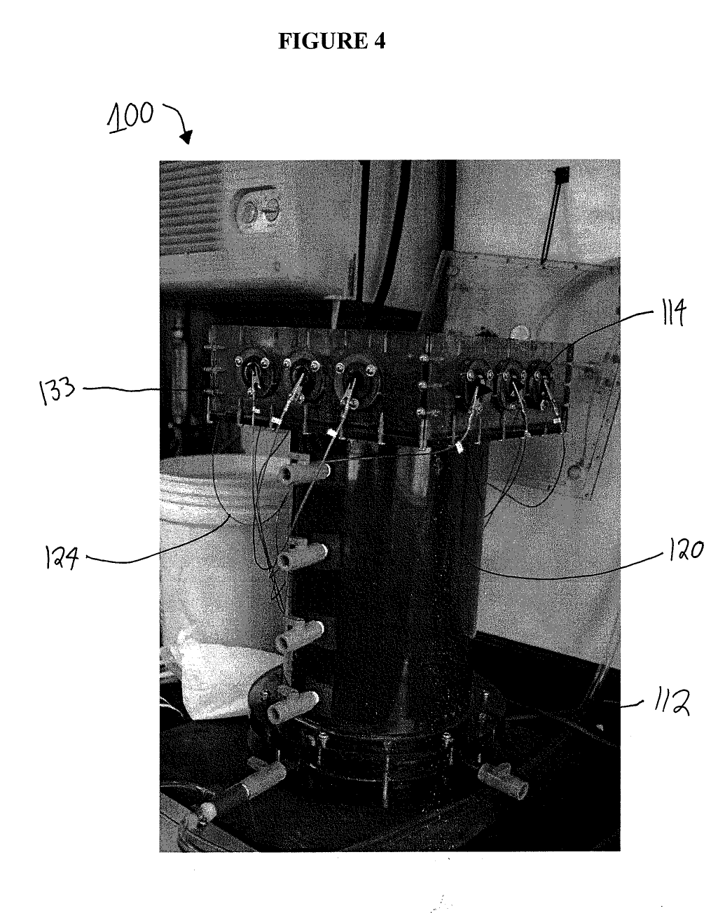

As shown in FIGS. 4, 5 and 6, chamber 120 of MFC 100 may include a top portion 133. Top portion 133 may be substantially rectangularly or squarely shaped, although the present disclosure is not limited thereto. Rather, top portion 133 may take a variety of shapes. Alternatively, MFC 100 may not include a top portion 133. In exemplary embodiments, the top portion 133 is configured and dimensioned to include, house, contain and/or be associated with at least one cathode 114. For example and as shown in FIGS. 4-6, top portion 133 may include a plurality of cathodes 114.

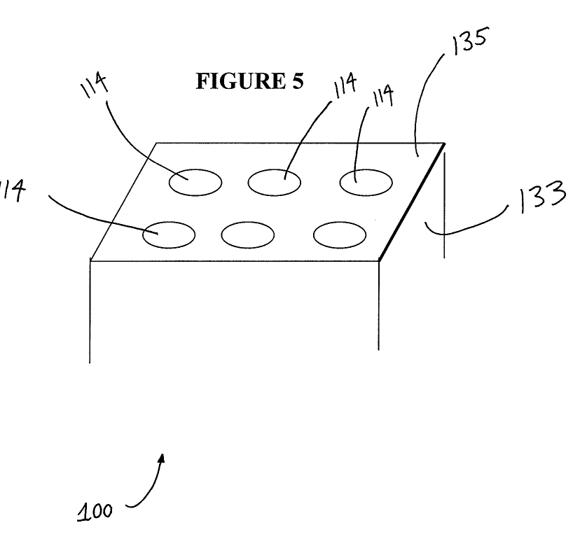

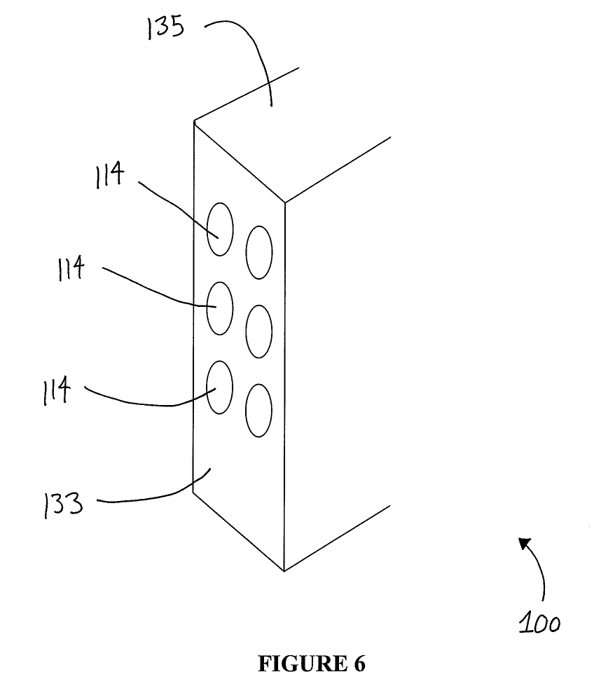

As noted, the chamber 120 typically includes or is associated with at least one cathode 114. In exemplary embodiments and as shown in FIGS. 2-6, the at least one cathode 114 is positioned along and/or in an upper portion of the chamber 120 (e.g., positioned along or adjacent to a peripheral or upper surface of the chamber 120). As depicted in FIGS. 2-6, the at least one cathode 114 may be horizontally or vertically positioned relative to the horizontal plane of the top side 135 of the chamber 120. For example and as shown in FIGS. 2 and 5, the at least one cathode 114 (e.g., carbon cloth) may be oriented substantially parallel relative to the horizontal plane of the top side 135 of the chamber 120. Alternatively and as shown in FIGS. 4 and 6, the at least one cathode 114 (e.g., carbon cloth) may be oriented at an acute angle or perpendicular relative to the horizontal plane of the top side of the chamber 120. The at least one cathode 114 may be mounted and/or secured to the MFC 100 (e.g., glued, adhered, fastened, etc. to the chamber 120, top portion 133, etc.). In one embodiment, MFC 100 includes multiple cathodes 114 (e.g., carbon cloths) that are vertically oriented at an acute angle or perpendicular relative to the horizontal plane of the top side 135 of the chamber 120. It has been found that such vertical positioning and/or configuration of the multiple cathodes 114 may reduce the accumulation of gas bubbles and/or pressure from the wastewater exerted on the at least one cathode 114, which thereby helps prevent deformation of the at least cathode positioned on or associated with the chamber 120, especially as compared to the deformation experienced by MFCs having a cathode positioned along the upper, open surface of chamber 120 to thereby substantially seal the upper, open surface of chamber 120 with the cathode material (e.g., carbon cloth). In general and as shown in FIGS. 5 and 6, at least a portion of each cathode 114 of MFC 100 is exposed to air.

Cathode 114 may take various forms and may be fabricated from known materials, e.g., a carbon cloth or coated carbon cloth or the like. For example, cathode 114 may be a coated carbon cloth that is positioned along the upper, open surface of chamber 120 to thereby substantially seal the upper, open surface of chamber 120 with the coated carbon cloth (FIG. 2). In one embodiment, the cathode 114 is a carbon cloth wherein substantially the entire piece and/or surface of the carbon cloth is utilized as the cathode of MFC 100.

In an alternative embodiment, chamber 120 may include a plurality of cathodes 114 (e.g., with each cathode being positioned along or adjacent to a peripheral or upper surface of the chamber 120, and/or with each cathode 114 of the plurality of cathodes being oriented at an acute angle or perpendicular relative to the horizontal plane, etc.). For example, chamber 120 may include or be associated with a plurality of cathodes 114, wherein each cathode is a separate and/or individual carbon cloth or piece of carbon cloth. It has been found that the number of cathodes (e.g., the number of individual carbon cloths or pieces of carbon cloth), instead of cathode surface area, plays an important role in power generation by MFC 100. For example, it has been found that multiple cathodes (e.g., multiple individual carbon cloths or pieces of carbon cloth) utilized by MFC 100 accelerated the reaction rate of electron acceptance and oxygen reduction on the cathodes. In an exemplary embodiment and as further discussed below, by inserting or positioning a plurality of conductive members 118 within the chamber and/or in contact/communication with the anode 112 (e.g., GAC bed), and by utilizing multiple cathodes (e.g., multiple carbon cloths oriented at an acute angle or perpendicular relative to the horizontal plane of the top side of the chamber), with each cathode being electrically connected to an individual conductive member 118, this thereby advantageously increased the power generation of MFC 100, as compared to certain embodiments wherein a MFC having only one cathode and only one conductive member 118 was operated.

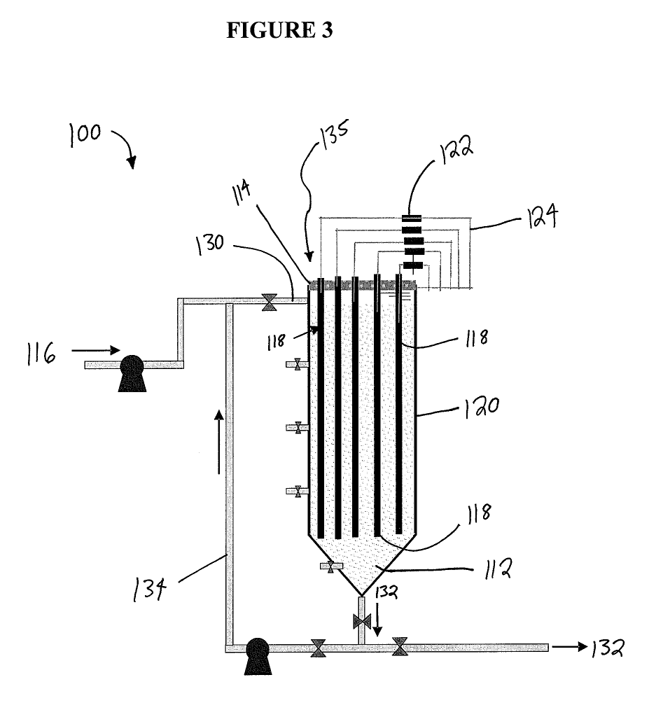

In exemplary embodiments, influent of a bacteria-containing substrate solution 116 passes through inlet 130 and enters the chamber 120, wherein the solution undergoes oxidation reactions (as described in greater detail below), and the effluent exits the chamber 120 via outlet 132. As shown in FIGS. 2 and 3, inlet 130 may be positioned at or mounted to an upper portion of the chamber 120, and outlet 132 may be positioned at or mounted to lower portion of the chamber 120, although the present disclosure is not limited thereto. Alternatively, inlet 130 may be positioned and/or mounted to the top portion 133 of MFC 100.

Effluent may be returned to the influent, in whole or in part, and recirculated throughout the chamber 120 by way of recirculation line 134. Effluent recirculation may be employed for various reasons, e.g., to adjust or maintain the flow rate through the chamber 120, to modify the bacteria concentration of the feedstock, and/or to ensure that the non-recirculated effluent reaches a desired level of purity/bacterial removal.

In exemplary embodiments, fuel cell 100 features an advantageous anode 112 that includes granular activated carbon (“GAC”) (e.g., a bed of GAC). Bacteria from the bacteria-containing solution adhere to the GAC and, as they are oxidized, generate electrons, for example, in accordance with equation (3), above. In general, the electrons generated through such oxidation are transferred to at least one conductive member 118 (e.g., a conductive rod, such as a graphite rod) which facilitates transfer to cathode 114. In exemplary embodiments, the electrons are further transferred to the cathode 114 through the external resistor 122 by way of the electrical circuit 124. In general, the at least one cathode 114 is electrically connected to the at least one conductive member 118 via the electrical circuit 124, which thereby facilitates electron transfer from the anode 112 to the cathode 114 via electrical circuit 124. Oxygen in air typically reacts with electrons and protons on the cathode and forms water. For example, protons created as a result of the substrate oxidation combine with the electrons in the presence of oxygen at the cathode 114, which is exposed to air, to form water.

Cathode 114 may be connected to a plurality of conductive members 118. Furthermore and as shown in FIGS. 3 and 4, chamber 120 may include a plurality of cathodes 114 and a plurality of conductive members 118, with each cathode 114 being connected to one individual conductive member 118 of the plurality of conductive members 118, thereby forming a plurality of individual electrical circuits 124 (e.g., a plurality of individual closed circuits 124). In one embodiment and as depicted in FIG. 4, MFC 100 includes twelve individual electrical circuits 124 (e.g, twelve individual closed circuits 124). In exemplary embodiments, chamber 120 may include a plurality of cathodes 114 and a plurality of conductive members 118, wherein the number of cathodes 114 in the plurality of cathodes equals the number of conductive members 118 in the plurality of conductive members.

As shown in FIGS. 2 and 3, at least a portion of the at least one conductive member 118 may be positioned within the chamber and/or in contact/communication with the anode 112 (e.g., GAC bed). At least a portion of the at least one conductive member 118 may be horizontally or vertically positioned relative to the horizontal plane of the top side 135 of the chamber 120. For example and as shown in FIG. 2, at least a portion of the at least one conductive member 118 (e.g., graphite rod) may be oriented substantially parallel relative to the horizontal plane of the top side of the chamber 120. In general and as shown in FIG. 2, at least a portion of the at least one conductive member 118 may be substantially horizontally positioned relative to the horizontal plane within a portion (e.g., an upper, middle or lower portion) of the chamber 120.

Alternatively and as shown in FIG. 3, at least a portion of the at least one conductive member 118 (e.g., graphite rod) may be oriented at an acute angle or perpendicular relative to the horizontal plane of the top side 135 of the chamber 120. In other words, at least a portion of the at least one conductive member 118 may be substantially vertically (e.g., transversely) positioned relative to the horizontal plane within a portion of the chamber 120. In one embodiment and as depicted in FIG. 3, at least a portion of the at least one conductive member 118 (e.g., graphite rod) is substantially vertically positioned relative to the horizontal plane (e.g., oriented at an acute angle or perpendicular relative to the horizontal plane) within the chamber 120, with the portion of the conductive member positioned within the chamber extending from a lower portion of the chamber to an upper portion of the chamber 120.

It has advantageously been found that such configuration and/or positioning of the at least one conductive member 118 vertically extending across the depth of the GAC bed substantially reduces the electron transfer resistance, thereby advantageously allowing electrons generated in the GAC bed to be effectively and efficiently collected. For example, by advantageously vertically positioning (e.g., orienting at an acute angle or perpendicular relative to the horizontal plane) the at least one conductive member 118 within the chamber 120 extending from a lower portion of the chamber to an upper portion of the chamber, this thereby reduces the distance between the at least one conductive member 118 and the cathode 114, which thereby significantly reduces the electron transfer resistance, especially the resistance in the lower portion of the chamber. Moreover, such advantageous vertical positioning of the at least one conductive member 118 extending from a lower portion of the chamber to an upper portion of the chamber may help to alleviate the accumulation of protons (H⁺) inside of the GAC bed. Furthermore, such vertical positioning of the at least one conductive member 118 configures the MFC 100 to be utilized as a vertical fixed biofilm wastewater treatment process, thereby making the configuration of MFC 100 easily applicable to existing wastewater treatment plants. Additionally and particularly in regards to large-scale MFC systems, the vertical positioning of the at least one conductive member 118 will lessen the pressure exerted on the conductive member 118 by the GAC bed compared to systems having conductive members horizontally positioned (e.g., oriented substantially parallel relative to the horizontal plane of the top side of the chamber) within the chamber, and especially as compared to conductive members which are horizontally positioned in a lower portion of the chamber and/or GAC bed.

As noted, chamber 120 may include a plurality of conductive members 118 (e.g., with at least a portion of each conductive member 118 being oriented substantially parallel relative to the horizontal plane of the top side of the chamber 120, or with at least a portion of each conductive member 118 being oriented at an acute angle or perpendicular relative to the horizontal plane, etc.). It has been found that by inserting or positioning (e.g., vertically) a plurality of conductive members 118 within the chamber and/or in contact/communication with the anode 112 (e.g., GAC bed), this substantially reduces the electron transfer resistance, thereby advantageously allowing electrons generated in the GAC bed to be effectively and efficiently collected.

Conductive member 118 may be fabricated from various conductive materials, e.g., graphite or another conductive material or the like. Exemplary conductive member 118 takes the form of a graphite rod or the like, although the present disclosure is not limited thereto. Rather, conductive member 118 may take any suitable form.

In exemplary embodiments, the anode 112 (e.g., GAC bed) is positioned at least in a lower portion of the chamber 120. In one embodiment, approximately half of the volume of chamber 120 is filled with GAC bed 112, although the present disclosure is not limited thereto. It is noted that the spacing between the anode 112 (e.g., GAC bed) and the cathode 114 may be adjusted by changing the amount of anode 112 in the chamber 120.

The single-chamber fuel cells of the present disclosure provide a number of advantages over prior art devices and methods. Because single-chamber MFCs do not depend on the use of a proton exchange membrane, their internal resistances are much lower than those observed in two-chamber MFCs, sometimes by a factor of about ten. This can significantly reduce the energy loss inside the exemplary MFCs provided by the present disclosure. Moreover, the simple geometry associated with the exemplary single-chamber MFC enables it to be applied more readily and easily to certain applications (e.g., wastewater treatment and/or power generation applications) compared to two-chamber MFCs, which require more components and occupy much more space. For example, the configuration of exemplary MFC 100 is similar to the biofilm process in wastewater treatment, thereby making the configuration of MFC 100 easily applicable to existing wastewater treatment plants. In exemplary embodiments, the MFC 100 (e.g., with the cylindrical configuration) may also thereby be utilized as a vertical biofilm process for wastewater treatment.

Moreover, GAC is readily available at a much lower cost than conventional electrodes/materials (e.g., polymer-coated electrodes, nanotube electrodes, etc.). In addition, the grains of the GAC have substantial surface areas (e.g., for improved bacterial growth), which permit greater bacterial adhesion and/or biofilm growth, thereby creating enhanced electron transfer from bacteria to the anode. It has been found that GAC itself is an excellent conductor of electrons. As a result, using GAC greatly enhances the bacterial adhesion and results in improved power generation and removal of contamination over MFCs of the prior art, including those employing two chambers and/or using anodes such as carbon cloths. Testing has confirmed that high power generation was achieved with exemplary MFCs, with the short spacing between anode (e.g., GAC bed) and cathode. For example, one experiment showed that with exemplary MFC 100 as depicted in FIG. 2, over 400 mV over the external resistance (Rₑₓₜ: 1000 ohm) was generated for 30 days without refilling the nutrient, and more than about 80% contaminant in the wastewater was removed. Another experiment showed that with exemplary MFC 100 as depicted in FIG. 4, about 960 mV over the external resistance of 100 ohm was generated (i.e, about 80 mV over the external resistance was generated by each of the twelve individual circuits 124), and more than about 80% contaminant removal efficiency was achieved with the effluent organic concentration of 20-30 mg/L. Additionally, exemplary MFC 100 as depicted in FIG. 4 has been operated with actual wastewater in continuous flow mode, which is a big step as compared to operating conventional MFCs with pure organic substances (e.g., acetate, glucose, etc.).

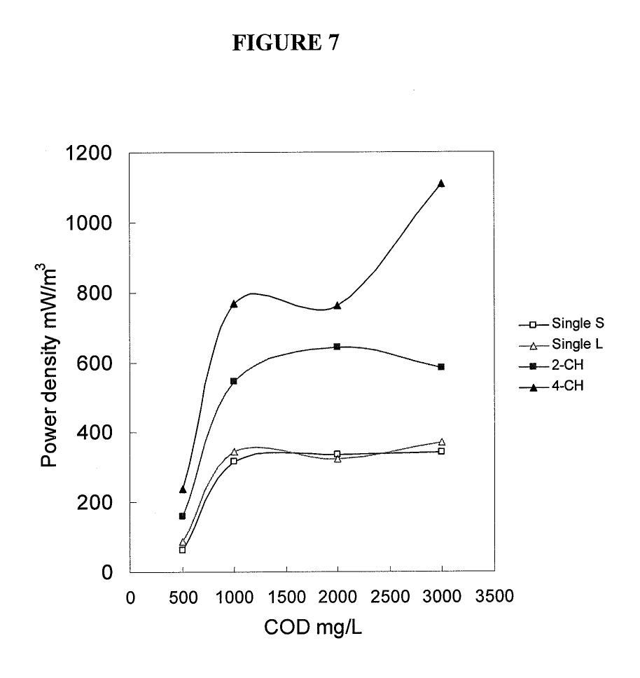

FIG. 7 depicts power generation results at different wastewater contaminant (chemical oxygen demand or COD) concentrations for various exemplary MFCs (Rₑₓₜ: 100 ohm) according to the present disclosure. As shown in FIG. 7, “Single S” refers to an exemplary MFC prepared according to the present disclosure having one cathode (cathode area about 39.2 cm²), “Single L” refers to an exemplary MFC prepared according to the present disclosure having one cathode (cathode area about 78.5 cm²), “2-CH” refers to an exemplary MFC prepared according to the present disclosure having two cathodes and two conductive members (i.e., two closed circuits), and “4-CH” refers to an exemplary MFC prepared according to the present disclosure having four cathodes and four conductive members (i.e., four closed circuits). As shown in FIG. 7, each of the four above-noted exemplary MFCs were tested at the wastewater contaminant (COD) concentrations of 500 to 3000 mg/L. The results showed that the exemplary MFCs containing more than one cathode (2-CH and 4-CH) produced much higher power as compared to the exemplary MFCs containing only one cathode (Single S and Single L). At COD of 1000 mg/L, the total power production of 2-CH (544 mW/m³) was twice as much as Single S (318 mW/m³), even with Single S having an equivalent cathode surface area to 2-CH. Also at COD of 1000 mg/L, the total power production of 4-CH (768 mW/m³) was 2.5 times more than Single L, even with Single L having an equivalent cathode surface area to 4-CH. At COD of 3000 mg/L, the power densities of 4-CH (1100 mW/m³) were about 3.0 times more than Single L (371 mW/m³). These results indicate that the configuration of having MFCs with multiple cathodes in a single unit (e.g., multiple closed circuits) substantially increases the power generation of the MFCs. Additionally, although the surface area of the cathodes (39.2 cm² versus 78.5 cm²) in the Single S and Single L MFCs were different, there was no noticeable difference between their power densities. In the 2-CH and 4-CH MFCs, each cathode channel (e.g., each closed circuit) had almost the same power as the Single S and the Single L MFCs, and the total power densities of 4-CH were nearly twice as compared to those of 2-CH. Thus, it has been found that by increasing the number of electronically isolated cathodes in an MFC may be more effective than increasing the cathode area, in terms of increasing the power production of the exemplary MFCs.

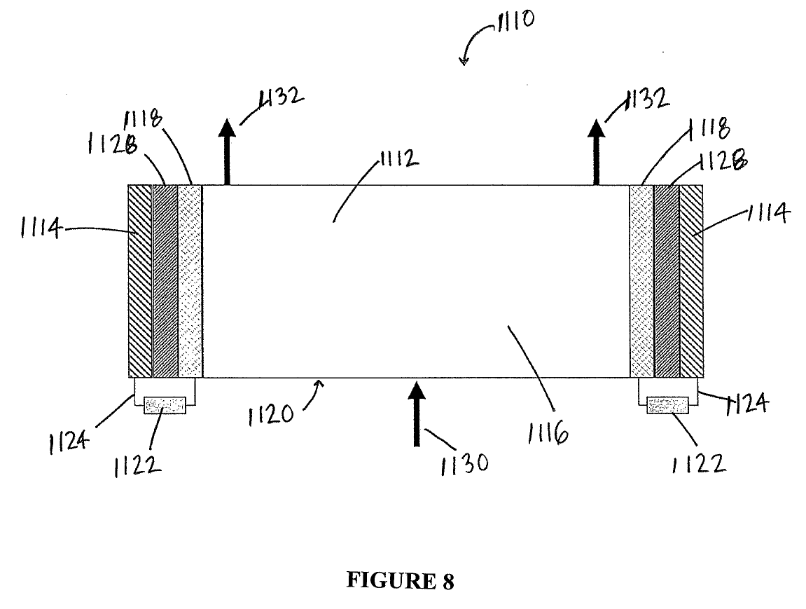

Another alternative embodiment of fuel cell 1110 of the present disclosure is shown in FIG. 8. In this exemplary embodiment, fuel cell 1110 shown may be referred to as a double-side anode-cathode MFC. In exemplary embodiments, the fuel cell 1110 has a single chamber 1120 that includes or defines an inlet 1130 for the injection of bacteria-containing substrate solution 1116 into the chamber 1120. In general, fuel cell 1110 further includes a pair of outlets 1132. Typically, within the chamber 1120 is a bed of GAC which acts as the anode 1112 and collects electrons generated by the bacterial oxidation reactions occurring therein. In exemplary embodiments, wastewater solution 1116 flows upwards from the bottom to inlet 1130, whereby it is then introduced to the GAC bed 1112. In general, the solution 1116 flows through the GAC bed and is collected on the upper portion of the chamber 1120.

In an exemplary embodiment and as shown in FIG. 8, anodic bases 1118 are mounted or positioned near the respective ends or sides of the chamber 1120 (e.g., a first anodic base 1118 is positioned at a first end of the chamber and a second anodic base is positioned at a second end of the chamber), and in the vicinity of each respective outlet 1132. Outside the chamber 1120, a pair of cathodes 1114 (e.g., carbon cloths) are mounted near each respective outlet 1132 (e.g., a first cathode 1114 is positioned outside of the first end of the chamber and adjacent to the first anodic base, and a second cathode is positioned outside of the second end of the chamber adjacent to the second anodic base). In exemplary embodiments, each cathode 1114 is separated from each anodic base 1118 by way of insulating material 1128.

During operation, wastewater flows through inlet 1130 and into the chamber 1120, and collects at the top of the GAC bed. Like the rod 118 of the fuel cell 100 in FIG. 2, the anodic bases 1118 collect the electrons generated through oxidation reactions on the GAC bed anode 1112. The electrons are then transferred from the anodic bases 1118 to the cathodes 1114 through electrical circuit 1124, and current passes through external resistor 1122. At least one advantage of exemplary MFC 1110 is that since the configuration of MFC 1110 is similar to the configuration of some aeration tanks and/or septic tanks, this thereby easily allows one to utilize exemplary MFC 1110 in many wastewater treatment applications such as, for example, municipal wastewater treatment plants and/or small community plants or the like. Moreover, exemplary MFC 1110 substantially fully utilizes the side-areas of the GAC bed 1112 and has a short distance between anode 1112 and/or anodic bases 1118 and cathodes 1114, which significantly reduces the energy loss inside exemplary MFC 1110.

A number of aspects of the present disclosure may be modified in order to achieve maximal results. For example, the distance between the cathode and the anode may be varied to maximize the performance thereof. The spacing of the electrodes may be adjusted, for example, by changing the level of the GAC bed in the chamber, or by varying the ratio of the chamber's height to the chamber's diameter, as necessary. The shape and configuration of the chamber, the inlet/outlet, and the electrical circuit, as well as the external resistances, may be modified. As noted, although the fuel cell 100 shown in FIG. 2 includes just one graphite rod 118, multiple rods may be inserted into the GAC bed, as necessary (e.g., FIG. 3). Moreover, the fuel cell of the present disclosure may be used as a standalone treatment option, or in series with other options.

Thus, it will be readily understood by those having skill in the pertinent art from the present disclosure that the exemplary fuel cells and corresponding methods of using these fuel cells to generate electrical power and to treat wastewater, are well suited for use in wastewater treatment. Accordingly, this detailed description of the currently preferred embodiments of the present disclosure is to be taken in an illustrative sense, as opposed to a limiting sense.

Although the systems and methods of the present disclosure have been described with reference to exemplary embodiments thereof, the present disclosure is not limited to such exemplary embodiments and/or implementations. Rather, the systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the claims be construed broadly and in a manner consistent with the scope of the disclosure.

1. A microbial fuel cell for generating electrical power, comprising:
(a) a chamber that defines an inlet and an outlet, the chamber having a top side defining a substantially horizontal plane; and
(b) an anode and a first cathode associated with the chamber, wherein the anode is defined at least in part from granular activated carbon.

2. The microbial fuel cell of claim 1, wherein the chamber is adapted to receive a bacteria-containing substrate through the inlet.

3. The microbial fuel cell of claim 2, wherein the granular activated carbon is present in an amount effective to facilitate bacterial adhesion thereto.

4. The microbial fuel cell of claim 1, wherein the chamber defines a single cell configuration.

5. The microbial fuel cell of claim 1, wherein the granular activated carbon is positioned in a lower portion of the chamber and the first cathode is positioned in an upper portion of the chamber.

6. The microbial fuel cell of claim 1, wherein the first cathode takes the form of carbon cloth.

7. The microbial fuel cell of claim 1, further comprising a conductive member to facilitate electron transfer from the anode to the first cathode.

8. The microbial fuel cell of claim 1, wherein operation is adjusted by controlling processing parameters selected from the group consisting of effluent recirculation, anode and first cathode spacing, conductive member selection and positioning, bacterial concentration of influent, bacterial composition of influent, geometry of chamber, and combinations thereof.

9. The microbial fuel cell of claim 7, wherein at least a portion of the conductive member is vertically oriented within the chamber at an acute angle or perpendicular relative to the horizontal plane of the top side of the chamber.

10. The microbial fuel cell of claim 1, wherein the first cathode is oriented at an acute angle or perpendicular relative to the horizontal plane of the top side of the chamber.

11. The microbial fuel cell of claim 9, wherein the first cathode is oriented at an acute angle or perpendicular relative to the horizontal plane of the top side of the chamber.

12. The microbial fuel cell of claim 1 further comprising a plurality of cathodes associated with the chamber.

13. The microbial fuel cell of claim 12, wherein the first cathode is oriented at an acute angle or perpendicular relative to the horizontal plane of the top side of the chamber; and
wherein each cathode of the plurality of cathodes is oriented at an acute angle or perpendicular relative to the horizontal plane of the top side of the chamber.

14. The microbial fuel cell of claim 1 further comprising a plurality of conductive members, each conductive member of the plurality of conductive members configured to facilitate electron transfer from the anode to the first cathode.

15. The microbial fuel cell of claim 14, wherein at least a portion of each conductive member of the plurality of conductive members is vertically oriented within the chamber at an acute angle or perpendicular relative to the horizontal plane of the top side of the chamber.

16. The microbial fuel cell of claim 1 further comprising a plurality of cathodes associated with the chamber and a plurality of conductive members;
wherein the first cathode and each cathode of the plurality of cathodes is oriented at an acute angle or perpendicular relative to the horizontal plane of the top side of the chamber; and
wherein at least a portion of each conductive member of the plurality of conductive members is vertically oriented within the chamber at an acute angle or perpendicular relative to the horizontal plane of the top side of the chamber.

17. The microbial fuel cell of claim 16, wherein the first cathode and each cathode of the plurality of cathodes is electrically connected to one individual conductive member of the plurality of conductive members, thereby forming a plurality of individual electrical circuits.

18. The microbial fuel cell of claim 17, wherein the number of conductive members in the plurality of conductive members equals the number of cathodes in the plurality of cathodes plus the first cathode.

19. The microbial fuel cell of claim 18, wherein the number of individual electrical circuits in the plurality of individual electrical circuits equals the number of conductive members in the plurality of conductive members.

20. The microbial fuel cell of claim 13, wherein the first cathode and each cathode of the plurality of cathodes is positioned in an upper portion of the chamber.

21. The microbial fuel cell of claim 9, wherein the portion of the conductive member vertically oriented within the chamber extends from a lower portion of the chamber to an upper portion of the chamber.

22. The microbial fuel cell of claim 16, wherein each portion of each conductive member of the plurality of conductive members vertically oriented within the chamber extends from a lower portion of the chamber to an upper portion of the chamber.

23. The microbial fuel cell of claim 1 further comprising a first anodic base, a second anodic base, and a second cathode associated with the chamber;
wherein the first anodic base is positioned at a first end of the chamber and the second anodic base is positioned at a second end of the chamber; and
wherein the first cathode is positioned outside of the first end of the chamber and adjacent to the first anodic base, and the second cathode is positioned outside of the second end of the chamber and adjacent to the second anodic base.

24. The microbial fuel cell of claim 23, wherein a first insulating material is positioned between the first anodic base and the first cathode, and a second insulating material is positioned between the second anodic base and the second cathode.

25. A method for generating electrical power from a fluid source, the method comprising:
(a) providing at least one microbial fuel cell that includes (i) a chamber defining an inlet and an outlet; and (ii) an anode and a cathode associated with the chamber, wherein the anode is defined at least in part from granular activated carbon;
(b) feeding a fluid stream containing bacteria through the inlet into the chamber, said bacteria adhering at least in part to the granular activated carbon;
(c) oxidizing bacteria to generate current between the anode and cathode; and
(d) discharging effluent through the outlet of the chamber, wherein the effluent contains a reduced bacterial level as compared to the fluid stream fed to the chamber.

26. The method of claim 25, wherein the fluid stream is wastewater.

27. The method of claim 25, wherein the chamber defines a single cell configuration.

28. The method of claim 25, wherein the granular activated carbon is positioned in a lower portion of the chamber and the cathode is positioned in an upper portion of the chamber.

29. The method of claim 25, wherein the cathode takes the form of carbon cloth.

30. The method of claim 25, further comprising a conductive member to facilitate electron transfer within the chamber.

31. The method of claim 25, wherein operation is adjusted by controlling processing parameters selected from the group consisting of effluent recirculation, anode and cathode spacing, conductive member selection and positioning, bacterial concentration of influent, bacterial composition of influent, geometry of chamber, and combinations thereof

32. A microbial fuel cell for generating electrical power, comprising:
a chamber that defines an inlet and an outlet, the chamber having a top side defining a substantially horizontal plane;
an anode and a plurality of cathodes associated with the chamber, wherein the anode is defined at least in part from granular activated carbon;
a plurality of conductive members, at least a portion of each conductive member of the plurality of conductive members being vertically oriented within the chamber at an acute angle or perpendicular relative to the horizontal plane of the top side of the chamber, with each portion of each conductive member of the plurality of conductive members vertically oriented within the chamber extending from a lower portion of the chamber to an upper portion of the chamber;
wherein each cathode of the plurality of cathodes is positioned in an upper portion of the chamber, and each cathode of the plurality of cathodes being oriented at an acute angle or perpendicular relative to the horizontal plane of the top side of the chamber;
wherein each cathode of the plurality of cathodes is electrically connected to one individual conductive member of the plurality of conductive members, thereby forming a plurality of individual electrical circuits;
wherein the number of conductive members in the plurality of conductive members equals the number of cathodes in the plurality of cathodes; and
wherein the number of individual electrical circuits in the plurality of individual electrical circuits equals the number of conductive members in the plurality of conductive members.
